(19) United States
(12) Patent Application Publication
(10) Pub. No.: US 2023/0317916 A1
(43) Pub. Date: Oct. 5, 2023

(54) HIGH ENERGY LI BATTERIES WITH LEAN LITHIUM METAL ANODES AND METHODS FOR PRELITHIATION

(71) Applicant: UNIVERSITY OF WASHINGTON, Seattle, WA (US)

(72) Inventors: Jihui Yang, Seattle, WA (US); Yao Liu, Seattle, WA (US); Xianyong Wu, Seattle, WA (US); Xiaoyu Jiang, Seattle, WA (US); Jun Liu, Seattle, WA (US)

(73) Assignee: UNIVERSITY OF WASHINGTON, Seattle, WA (US)

(21) Appl. No.: 18/002,237

(22) PCT Filed: Jun. 29, 2021
(86) PCT No.: PCT/US2021/039491

§ 371 Date: Dec. 16, 2022

Related U.S. Application Data
(60) Provisional application No. 63/046,918, filed on Jul. 1, 2020.

(51) Int. Cl. H01M 4/66; H01M 12/08; H01G 11/32; H01G 11/62; H01M 4/04; H01M 4/133; H01M 10/052; H01G 11/28; C25D 3/42; H01G 11/50; H01M 4/587; H01M 12/02

(52) U.S. Cl. CPC H01M 4/045; C25D 3/42; H01G 11/28; H01G 11/32; H01G 11/50; H01G 11/62; H01M 4/133; H01M 4/587; H01M 4/661; H01M 10/052; H01M 12/02; H01M 12/08; H01M 2300/0034; H01M 2300/0037

(57) ABSTRACT

The present disclosure provides the use of prelithiated hard carbon in the preparation of lean lithium metal anode electrode, the incorporation of the lean lithium metal anode electrode into full cells, and the evaluation of the electrochemical performances in the full cell under practical conditions. A full cell using the prelithiated hard carbon with lean lithium metal anode electrode and a high-capacity cathode can exhibit high energy density, high Coulombic efficiency, and long cycling life.

### CROSS-REFERENCE(S) TO RELATED APPLICATION(S)

This application claims the benefit of U.S. Pat. Application No. 63/046,918, filed Jul. 1, 2020, the disclosure of which is hereby incorporated by reference in its entirety.

### STATEMENT OF GOVERNMENT LICENSE RIGHTS

This invention was made with government support under Grant No. DE-EE0007763, awarded by the U.S. Department of Energy. The government has certain rights in the invention.

### BACKGROUND

Lithium metal has been regarded as the best choice for next-generation high-energy density rechargeable lithium batteries, due to its ultra-high capacity of 3860 mAh g⁻¹ and the lowest redox potential of -3.04 V vs. standard hydrogen electrode. However, two major hurdles have severely delayed the commercialization of lithium metal anodes. First, lithium metals are prone to dendrite growth during the plating/stripping process, which may penetrate separators, cause the internal short circuits, and further result in thermal runaway and cell catching-fire or explosion. The other challenge is the low Coulombic efficiency of lithium (Li) plating, which is rooted in the high reactivity of lithium metal and the instability of the solid-electrolyte interface (SEI). During the repetitive plating/stripping process, the crack of SEI, the continuous consumption of electrolytes, and/or the formation of dead Li metals, will considerably restrict the cycling life. To address these challenges, tremendous efforts have been employed to improve the Li metal performance, such as using three-dimensional current collectors, optimizing the composition of electrolytes, and applying solid-state electrolyte. Despite the improvement, these approaches usually employ excessive lithium metals to assemble full cells, which greatly restrict the practical energy density.

To improve the comprehensive performance of lithium batteries, such as energy density, cycle stability, safety, manufacture, there exists a pressing need to develop Li anode that exhibits high capacity, high Coulombic efficiency, and long cycling life. In addition, the full cell should be carefully designed with practical negative/positive (N/P) capacity ratio and lean electrolytes. The present disclosure seeks to fulfill these needs and provides further related advantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a lithium full cell, including: an anode including an anode active material and an anode current collector, the anode active material includes a hard carbon material, a carbon fiber, a carbon nanotube, a graphene, a graphite, a doped carbon material, or any combination thereof, a cathode including a cathode active material and a cathode current collector, a separator between the anode and the cathode; and an electrolyte wetting the anode, the cathode, and the separator. The anode active material is prelithiated with a lithium metal prior to an initial charge and the prelithiated anode active material hosts the lithium metal and has an N/P ratio of less than 1 as a function of the cathode active material.

In another aspect, the present disclosure features a method of prelithiating an anode, including providing an anode including an anode active material, the anode active material includes a hard carbon material, a carbon fiber, a carbon nanotube, a graphene, a graphite, a doped carbon material, or any combination thereof; providing a lithium source; and prelithiating the anode active material using the lithium source to provide a prelithiated anode prior to an initial charge. The anode active material hosts the lithium metal and has an N/P ratio less than 1 as a function of a lithium intercalation cathode material.

In yet another aspect, the present disclosure features a method of making a lithium full cell, including incorporating the prelithiated anode made using the method described herein into a cell that includes a cathode and a separator between the anode and the cathode.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1A is a schematic representation of an example of an embodiment of a prelithiated carbon-based material obtained through an electrochemical process, also shown in FIG. 1A is a full cell assembly.

FIG. 1B is a schematic representation of an example of an embodiment of a prelithiated hard carbon obtained by adding “Li-donor” additives in the cathode electrode. During an initial prelithiation process, the lithium ions deriving from “Li-donor” additives transfer from cathode to anode to complete the prelithiation process.

FIG. 1C is a schematic representation of an example of an embodiment of a prelithiated hard carbon obtained by coating lithium metal powders on current collectors. The hard carbon can react with lithium metal powders to complete the prelithiation process.

FIG. 2 is an X-ray diffraction pattern of an example of an embodiment of a hard carbon. In the Example of the present disclosure, commercial hard carbon material was used directly without further treatment The broad and wide XRD patterns indicate the amorphous nature of hard carbon.

FIG. 3 is a scanning electron microscope image of an embodiment of a hard carbon. The hard carbon exhibits an irregular morphology with a typical size of about 10 µm.

FIG. 4 is a graph of a discharge capacity vs. cycle number of an embodiment of a lithium metal full cell with a copper foil anode and a LiNi_{0.6}Co_{0.2}Mn_{0.2}O₂ (NCM622) cathode.

FIG. 5 is a graph of a discharge capacity vs. cycle number of an embodiment of a lithium metal full cell with a hard carbon coated on copper foil anode and a NCM622 cathode.

FIG. 6 is a graph of a discharge capacity vs. cycle number of an embodiment of a lithium metal full cell with a prelithiated hard carbon anode and a NCM622 cathode. The half-cell was assembled with hard carbon and lithium metal. The half cell was discharged to 0 V vs. Li/Li⁺ under a current density of 0.1 mA cm⁻², and then disassembled in a glove box under inert atmosphere. The full cell was assembled using the prelithiated hard carbon electrode and NCM622 cathode.

FIG. 7 is a graph of a discharge capacity vs. cycle number of an embodiment of a lithium metal full cell with a prelithiated hard carbon and a NCM622 cathode. The half cell was assembled with hard carbon and lithium metal. The half-cell was discharged to the capacity of 1 mAh cm⁻² under a current density of 1 mA cm⁻², and then disassembled in a glove box under inert atmosphere. The full cell was assembled using the prelithiated hard carbon electrode and NCM622 cathode.

FIG. 8 is a graph of discharge capacity vs. cycle number of an embodiment of a lithium metal full cell with a prelithiated hard carbon and a NCM622 cathode. The half cell was assembled with hard carbon and lithium metal. The half cell was discharged to the capacity of 2 mAh cm⁻² under a current density of 1 mA cm⁻², and then disassembled in a glove box under inert atmosphere. The full cell was assembled using the prelithiated hard carbon electrode and NCM622 cathode.

FIG. 9 is a graph of discharge capacity vs. cycle number of an embodiment of a lithium metal full cell with a prelithiated hard carbon and a NCM622 cathode. The half-cell was assembled with hard carbon and lithium metal. The half cell was discharged to the capacity of 4 mAh cm⁻² under a current density of 1 mA cm⁻², and then disassembled in a glove box under inert atmosphere. The full cell was assembled using the prelithiated hard carbon electrode and NCM622 cathode.

FIG. 10 is a graph of discharge capacity vs. cycle number of an embodiment of a lithium metal full cell with a pure Li anode (1.6 mAh cm⁻²) and a LiNi_{0.8}Co_{0.1}Mn_{0.1}O₂ (NCM811) cathode.

FIG. 11 is a graph of a discharge capacity vs. cycle number of an embodiment of a lithium metal full cell with a prelithiated hard carbon and a NCM811 cathode. The half cell was assembled with hard carbon and lithium metal. The half cell was discharged to the capacity of 1.6 mAh cm⁻² under a current density of 0.1 mA cm⁻², and then disassembled in a glove box under inert atmosphere. The full cell was assembled using the prelithiated hard carbon electrode and NCM811 cathode.

FIG. 12 is an electrochemical impedance spectroscopy (EIS) spectrum of embodiments of full cells at the open-circuit voltage (OCV). The full cells include NCM622 as the cathode and the prelithiated hard carbon (4 mAh cm⁻², represented by hard carbon/Li in Figure) or predeposited copper foil (4 mAh cm⁻², represented by Cu/Li in Figure) as the anode. The EIS tests were performed over the frequency range of 10⁻²-10⁵ Hz with an AC signal amplitude of 5 mV at a stable OCV.

### DETAILED DESCRIPTION

The present disclosure provides the use of prelithiated hard carbon in the preparation of lean lithium metal anode electrode, the incorporation of the lean lithium metal anode electrode into full cells, full cells including the lean lithium metal anode electrode, and the evaluation of the electrochemical performances in the full cells under practical conditions. The prelithiation process includes the electrochemical Li deposition, addition of lithium metal on current collector, and introduction of “Li donor” additives in cathode materials. These methods can precisely control the amount of lithium metal and can be compatible with the industrial production. During the prelithiation process, a stable SEI layer is formed, which is an ionic conductor but electronic insulator. The lithium can deposit under the SEI layer, which isolates the contact between Li metal and electrolytes. In addition, the lower electronic conductivity of hard carbon can induce Li metals to plate between carbon and current collectors, which further stabilizes the SEI layer and suppress Li dendrite growth. In some embodiments, localized high concentration electrolytes (LHCEs) can be used to improve electrochemical performances. As will be described herein, a full cell that includes prelithiated hard carbon with lean lithium metal anode electrode and high-capacity cathode (e.g.. LiNiₓCo_{y}Mn_{1-x-y}O₂ (x≥0.6, NCM)) can exhibit high energy density, high Coulombic efficiency, and long cycling life.

### Definitions

As used herein, the term “battery” is used interchangeably with “cell” or “full cell.”

As used herein, the term “dendrites” refers to the needle-like dendritic crystals that form on the surface of a lithium electrode during charging/discharging of a lithium battery.

As used herein, the term “lean lithium metal” refers to a full cell having an N/P ratio ≤ 1 and/or an areal capacity of less than or equal to 4 mAh cm⁻²,

As used herein, the term “lean electrolyte” refers to conditions where the electrolyte amount is reduced to an amount of 7 g/Ah or less and/or 3 g/Ah or more (e.g., from 3 g/Ah to 7 g/Ah).

As used herein, mass loading cathode refer to weight of cathode material per unit area, and a high mass loading cathode has a mass loading of at least 1 ± 0.1 mg cm⁻² and up to 25 ± 3 mg cm⁻².

As used herein, the term “practical conditions” refers to high-areal-capacity cathode loading (e.g., > 4 mAh cm⁻²), lean electrolyte amount (e.g., from 3 g/Ah to 7 g/Ah), and lean Li amount (e.g., ≤ 4 mAh em⁻²).

As used herein, the term “prelithiated” or “prelithiation” refers to a pretreatment of the anode for lithium ion batteries, in which Li metal is added to the anode before the initial charge/discharge cycle.

As used herein, the term “alkyl” refers to a saturated hydrocarbon group which is straight-chained (e.g., linear) or branched. Example alkyl groups include methyl (Me), ethyl (Et), propyl (e.g., n-propyl and isopropyl), butyl (e.g., n-butyl, isobutyl, t-butyl), pentyl (e.g., n-pentyl, isopentyl, neopentyl), and the like. An alkyl group can contain from 1 to about 30, from 1 to about 24, from 2 to about 24, from 1 to about 20, from 2 to about 20, from 1 to about 10, from 1 to about 8, from 1 to about 6, from 1 to about 4, or from 1 to about 3 carbon atoms.

As used herein, a “liquid” is a substance which flows freely at room temperature, such that its shape changes but its volume retains constant, e.g., as would water or an oil.

As used herein, “room temperature” denotes a typical ambient indoor temperature of about 25° C.

Unless defined otherwise, any feature within any aspect or embodiment of the disclosure may be combined with any feature within any other aspect or embodiment of the invention, and such combination are encompassed in the present disclosure. This also applies, but not exclusively, to endpoints of ranges disclosed herein. For instance, if a given substance is disclosed as existing in a composition in a concentration range of X-Y% or A-B%, the present disclosure is to be understood as explicitly disclosing not only the ranges X-Y% and A-B%, but also the ranges X-B%, A-Y% and, in as far as numerically possible, Y-A% and B-X%. Each of these ranges, and range combinations, are contemplated, and are to be understood as being directly and unambiguously disclosed in the present application.

Unless stated otherwise, the designation of a range in the present application using a hyphen (“-”) separating two bracketing values X and Y, or two bracketing ratios, is to be understood as meaning and disclosing the specified range in which both endpoint values X and Y are included. The same applies to a range expressed as “from X to Y”. Accordingly, the expressions of ranges as “X-Y”, “of X to Y”, “from X to Y”, “of X-Y” and “from X-Y” are to be understood equivalently as meaning and disclosing a range encompassing the end value X, all values (including decimals) between X and Y, as well as the end value Y.

As used herein the term “about” when referring to a particular value, e.g., an endpoint or endpoints of a range, encompasses and discloses, in addition to the specifically recited value itself, a certain variation around that specifically recited value. Such a variation may for example arise from normal measurement variability, e.g., in the weighing or apportioning of various substances by methods known to the skilled person. The term “about” shall be understood as encompassing and disclosing a range of variability above and below an indicated specific value, said percentage values being relative to the specific recited value itself, as follows: The term “about” may encompass and disclose variability of ± 5.0%. The term “about” may encompass and disclose variability of ± 4.5%. The term “about” may encompass and disclose variability of ± 4.0%. The term “about” may encompass and disclose variability of ± 3.5%. The term “about” may encompass and disclose variability of ± 3.0%. The term “about” may encompass and disclose variability of ± 2.5%. The term “about” may encompass and disclose variability of ± 2.0% The term “about” may encompass and disclose variability of ± 1.5%. The term “about” may encompass and disclose variability of ± 1.0%. The term “about” may encompass and disclose variability of ± 0.5%. The term “about”, in reference to the particular recited value, may encompass and disclose that exact particular value itself, irrespective of any explicit mention that this exact particular value is included; even in the absence of an explicit indication that the term “about” includes the particular exact recited value, this exact particular value is still included in the range of variation created by the term “about”, and is therefore disclosed in the present application. Unless stated otherwise, where the term “about” is recited before the first endpoint of a numerical range, but not before the second endpoint of that range, this term, and the variability it implies in scope and disclosure, refers to both the first endpoint of the range and the second endpoint of the range. For instance, a recited range of “about X to Y” should be read as “about X to about Y”. The same applies for a recited range of ratios. For instance, a recited range of weight ratios of “about X:Y -A:B″ should be read as a weight ratio of “(about X):(about Y) - (about A):(about B)”.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise,” “comprising,” and the like are to be construed in an inclusive sense as opposed to an exclusive or exhaustive sense: that is to say, in the sense of “including, but not limited to.” Words using the singular or plural number also include the plural and singular number, respectively. Additionally, the words “herein,” “above,” and “below” and words of similar import, when used in this application, shall refer to this application as a whole and not to any particular portions of the application.

Specific elements of any foregoing embodiments can be combined or substituted for elements in other embodiments. Moreover, the inclusion of specific elements in at least some of these embodiments may be optional, wherein further embodiments may include one or more embodiments that specifically exclude one or more of these specific elements. Furthermore, while advantages associated with certain embodiments of the disclosure have been described in the context of these embodiments, other embodiments may also exhibit such advantages, and not all embodiments need necessarily exhibit such advantages to fall within the scope of the disclosure.

Example devices, methods, and systems are described herein. It should be understood the words “example,” “exemplary,” and “illustrative” are used herein to mean “serving as an example, instance, or illustration.” Any embodiment or feature described herein as being an “example,” being “exemplary,” or being “illustrative” is not necessarily to be construed as preferred or advantageous over other embodiments or features.

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings and/or examples making apparent to those skilled in the art how the several forms of the disclosure may be embodied in practice.

Unless otherwise defined, all technical and scientific terms used herein have the same meaning as commonly understood by one of ordinary skill in the art. Although methods and materials similar or equivalent to those described herein can be used in the practice or testing of the present disclosure, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

It will be readily understood that the aspects of the present disclosure, as generally described herein, and illustrated in the figures, can be arranged, substituted, combined, separated, and designed in a wide variety of different configurations, all of which are explicitly contemplated herein.

Furthermore, the particular arrangements shown in the FIGURES should not be viewed as limiting. It should be understood that other embodiments may include more or less of each element shown in a given FIGURE. Further, some of the illustrated elements may be combined or omitted. Yet further, an example embodiment may include elements that are not illustrated in the FIGURES.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

### Lithium Full Cells

The present disclosure features a lithium full cell including an anode which includes an anode active material and an anode current collector. The anode active material can include a hard carbon material, a carbon fiber, a carbon nanotube, a graphene, a graphite, a doped carbon material, or any combination thereof. The lithium full cell also includes a cathode that includes a cathode active material and a cathode current collector. The lithium full cell further includes a separator between the anode and the cathode; and an electrolyte wetting the anode, the cathode, and the separator. The anode active material is prelithiated with a lithium metal prior to an initial charge. The anode active material hosts the lithium metal for the prelithiation and has an N/P ratio of less than 1 (e.g., 0.95 or less, 0.9 or less, 0.85 or less, 0.8 or less, 0.6 or less, 0.5 or less, or 0.3 or less) and/or 0.25 or more (e.g., 0.3 or more, 0.5 or more, 0.6 or more, 0.8 or more, 0.85 or more, 0.9 or more, or 0.95 or more) as a function of the cathode active material. As used herein, the N/P ratio describes the capacity ratio between the negative/positive electrodes in the cell. The N/P ratio for Li metal batteries is calculated using the areal capacities in units of mAh cm⁻² for the Li metal anode and cathode. For example, for a given cathode areal capacity of 4 mAh cm⁻², if the anode active material is prelithiated and hosts 4 mAh cm⁻² Li metal, then the N/P ratio is 1. As another example, if a prelithiated anode active material hosts 2 mAh cm⁻² Li metal, the N/P ratio is 0.5.

In some embodiments, the anode has an average anode active material mass loading of less than 1 mg cm⁻² (e.g.. less than 0.9 mg cm⁻², less than 0.8 mg cm⁻², or less than 0.7 mg cm⁻²) and/or greater than 0.1 mg cm⁻² (e.g., greater than 0.2 mg cm⁻², greater than 0.3 mg cm⁻², greater than 0.4 mg cm⁻², greater than 0.5 mg cm⁻², or greater than 0.6 mg cm⁻²) for the anode, and/or the cathode has an average cathode active material mass loading of up to 25 mg cm⁻² (e.g., up to 22 mg cm⁻², up to 20 mg cm⁻², up to 18 mg cm⁻², or up to 15 mg cm⁻²). The full cell can reach a specific energy of at least 350 Wh kg⁻¹ (e.g., at least 360 Wh kg⁻¹, at least 380 Wh kg⁻¹, at least 400 Wh kg⁻¹, at least 420 Wh kg⁻¹, or at least 440 Wh kg⁻¹). The full cell can have a lean lithium metal, lean electrolyte, and/or a high mass loading cathode.

In some embodiments, when the anode active material includes a carbon material (e.g., a first carbon material), the carbon material can be substituted with one or more of: a carbon material different from the (first) carbon material (e.g., a carbon fiber, a carbon nanotube, a graphene, a graphite, and/or a doped carbon material): an element such as N. O, P, S, Cl, Br, and/or I; an alloy that includes the elements Ag, Au, Mg, Zn, Si, Ge, Sn, Pb, Sb, Bi, and/or Al; an oxide such as TiO₂, SiO_{x,} GeO₂, and/or SnO₂; a nitride such as Li₃N and/or Sn₃N₄; and/or a sulfide such as Li₂S, TiS₂.

In some embodiments, when the anode active material includes a hard carbon material, the hard carbon material can be substituted with one or more of: a carbon material different from the hard carbon material (e.g., a carbon fiber, a carbon nanotube, a graphene, a graphite, and/or a doped carbon material); an element such as N, O, P, S, Cl, Br, and/or I: an alloy that includes the elements Ag, Au, Mg, Zn, Si, Ge, Sn, Pb, Sb, Bi, and/or Al; an oxide such as TiO₂, SiOₓ, GeO₂. and/or SnO₂: a nitride such as Li₃N and/or Sn₃N₄; and/or a sulfide such as Li₂S, TiS₂.

In some embodiments, the anode active material has a thickness of from 1 µm (e.g., from 5 µm, from 10 µm, from 15 µm, from 20 µm, or from 25 µm) to 30 µm (e.g., to 25 µm, to 20 µm, to 15 µm, to 10 µm, or to 5 µm).

The cathode active material can have a capacity of greater than 200 mAh/g (e.g., greater than 220 mAh/g, greater than 240 mAh/g, greater than 260 mAh/g, greater than 280 mAh/g, or greater than 300 mAh/g) and an operation potential of greater than 4.0 V (e.g., greater than 4.2 V, greater than 4.4 V, greater than 4.6 V, greater than 4.8 V. or greater than 5.0 V) vs. Li/Li⁺. The cathode active material can include a high-nickel-content lithium nickel manganese cobalt oxide (high-Ni NCM), where the nickel amount can be equal to or greater than 60 mol %. Li-rich layered cathode materials (e.g., Li_{1.2}Ni_{0.2}Mn_{0.6}O₂; xLi₂MnO₃ · (1-x)LiMn_{0.5}Ni_{0.5}O₂ (0<x<1); xLi₂MnO₃ · (1-x)LiMO₂ (M = Mn. Ni, Co) (0<x<1)) and/or lithium cobalt oxide (LiCoO₂), or any combination thereof. In a preferred embodiment, the cathode active material includes lithium cobalt oxide (LiCoO₂). The areal density of the cathode can be up to 4 mAh cm⁻² (e.g.. up to 3.8 mAh cm⁻², up to 3.6 mAh cm⁻², or up to 3.4 mAh cm⁻²), which equals a mass loading of up to 25 mg cm⁻² (e.g., up to 23.75 mg cm⁻², up to 22.5 mg cm⁻², or up to 21.25 mg cm⁻²),

In some embodiments, the anode current collector includes a thin sheet of any conductive material, such as a carbon paper, a copper (Cu) foil, a nickel foil, a stainless steel foil, a decorated copper foil, and/or a decorated nickel foil. In a preferred embodiment, the anode current collector is a copper foil current collector.

The cathode current collector can be formed of a thin conductive material. In some embodiment, the cathode current collector includes an aluminum (Al) foil current collector, a stainless steel foil, a carbon-coated aluminum foil, or any combination thereof.

In some embodiments, the separator includes a polyethylene film, a polypropylene film, a poly (tetrafluoroethylene) film, a polyvinyl chloride film, nonwoven cotton fibers, nonwoven nylon fibers, nonwoven polyester fibers, ceramic, rubber, asbestos, wood, hybrids thereof, derivatives thereof, or any combination thereof.

The amount of electrolyte is controlled at 7 g/Ah or less (e.g., 6 g/Ah or less, 5 g/Ah or less, or 4 g/Ah or less) and/or 3 g/Ah or more (e.g., 4 g/Ah or more, 5 g/Ah or more, or 6 g/Ah or more) (i.e., lean electrolyte conditions). For example, the amount of electrolyte is from 3 g/Ah to 7 g/Ah. A wide range of electrolytes can be used for fabricating the full cell of the present disclosure. For example, the electrolytes can include non-aqueous electrolytes, all-solid inorganic electrolytes, and/or polymer-based electrolytes. The non-aqueous electrolytes can be made up by dissolving a lithium salt in the non-aqueous solvent at different concentrations.

The electrolyte can include lithium salts that are, for example, dissolved in a solvent. In some embodiments, the solvent includes carbonates and/or ethers. Non-limiting examples of carbonates include ethylene carbonate (EC), diethyl carbonate (DEC), ethyl methyl carbonate (EMC), dimethyl carbonate (DMC), and/or propylene carbonate (PC). Non-limiting examples of ethers include 1,3-dioxolane (DOL), 1,2-dimethoxyethane (DME), triethyl phosphate (TEP). 1,1,2,2-tetrafluoroethyl-2,2,3,3-tetrafluoropropyl ether (TTE), bis(2,2,2-trifluoroethyl) ether (BTFE), fluorinated ether (TFEE), and/or tetraethylene glycol dimethyl ether (TGEDEM).

In some embodiments, the solvent is a binary or ternary combination of the carbonates and/or ethers, e.g., at various volume ratios or gravity ratios. Examples of combinations of carbonates and/or ether include DME and TTE, DME and BTFE, TEP and BTFE, or a mixture of DME, TTE, and BTFE.

In some embodiments, the electrolyte includes LiFSI-DME-TTE. For example, the LiFSI-DME-TTE can be in a molar ratio of 1:1.2:3. A LiFSI-DME-TTE electrolyte can have a wide electrochemical voltage window; high ionic conductivity; good compatibility with lithium metal; and/or superior ability to homogenize lithium deposition.

In some embodiments, the lithium salt in the electrolyte includes LiPF₆, LiAsF₆, lithium bis(trifluoromethanesulfonyl)imide (LiTFSI), lithium bis(fluorosulfonyl)imide (LiFSI), LiClO₄, and/or LiBF₄. The concentration of the lithium salt in the electrolyte can be 0.5 mol L⁻¹ or more (e.g., 1 mol L⁻¹ or more, 2 mol L⁻¹ or more, or 3 mol L⁻¹ or more) and/or 4 mol L⁻¹ or less (e.g., 3 mol L⁻¹ or less, 2 mol L⁻¹ or less, or 1 mol L⁻¹ or less) relative to the electrolyte volume.

In some embodiments, the lithium full cell has an N/P capacity ratio of 0.25 or more and 1 or less (e.g., between 0.25 and less than 1). For example, the lithium full cell can have an N/P capacity ratio (also referred to herein as N/P ratio) of less than 1 (e.g., 0.95 or less, 0.9 or less, 0.85 or less, 0.8 or less, 0.6 or less. 0.5 or less, or 0.3 or less) and/or 0.25 or more (e.g., 0.3 or more, 0.5 or more, 0.6 or more, 0.8 or more, 0.85 or more, 0.9 or more, or 0.95 or more).

The lithium used in the prelithiation of the anode active material can be a lithium from the anode or cathode. The lithium from the anode can be provided by Li from a Li foil and/or Li powder on the anode. In a preferred embodiment, the lithium from the anode is provided by a thin lithium foil. In some embodiments, the thin lithium foil has a thickness of 30 µm or more (e.g., 35 µm or more, 40 µm or more, or 45 µm or more) and/or 50 µm or less (e.g., 45 µm or less, 40 µm or less, or 35 µm or less). Prelithiating the anode can include adding an electrolyte to electrically connect the anode active material and the lithium.

In some embodiments, the anode includes a prelithiated lithium metal provided by an amount of Li donor additives in the cathode and/or a coating of a lean lithium metal on a negative current collector. The Li donor additives can include Li₃N, Li₂S, Li₂O, and/or Li₃P. The lithium donor additives and/or the lithium metal can have varying particle sizes and/or crystalline structures. In some embodiments, the Li donor additive can be a reaction product of lithium metal and metallic oxide, e.g., CuO, Co₃O₄, MnO₂, and/or Fe₂O₃, etc. The amount of Li donor additive can be from 1 wt% (e.g.. from 2 wt%, from 3 wt%, or from 4 wt%) to 5 wt% (e.g., to 4 wt%, to 3 wt%, or to 2 wt%). In some embodiments, the amount of Li donor additive can minimize the energy density decrease of full cell. The lithium donor additives can have high air stability (i.e., the additives remain stable for at least 24 hours when exposed to ambient air having 78% nitrogen and 21% oxygen), large theoretical capacity of up to 400 mAh g⁻¹, and an acceptable decomposition potential of less than 4.4 V Li/Li⁺. Prelithiating the anode active material can include electrochemical decomposition of the Li donor additive.

The full cells of the present disclosure are superior compared to existing lithium batteries that use Li-Cu or Li-C anodes coupled to the high-Ni content NCM composite cathode, where an excessive lithium metal (N/P ratio >2) is employed to prolong the lifespan of a full cell, resulting in markedly decreased full cell energy density, and where the excessive lithium metal accelerate the consumption of electrolyte because of the continuous reaction of lithium metal with electrolytes, which results in the rapid fading of full cells. In addition, unlike existing lithium batteries, the full cells of the present disclosure do not need to made by a melt infusion method, which requires rigorous low oxygen and low water condition, which restricts their practical application.

In some embodiments, the full cell is a lithium-sulfur battery, a lithium-air rechargeable battery, an electrochemical supercapacitor, and/or a hybrid-supercapacitor.

### Prelithiation Methods

In some embodiments, prelithiating the anode includes electrochemical deposition of a lithium metal onto the anode active material. During the prelithiation process, the current density and prelithiation time are used to control the prelithiation capacity. The prelithiation process is different from a charging process (e.g., an initial charging process) and is not part of the charging process. For example, the charging process includes intercalation of lithium into the molecular structure of the anode active material, whereas the prelithiation process deposits lithium onto the anode active material. As an example, the electrochemical prelithiation deposition process can include providing a given amount of Li metal, and plating the Li metal on a carbon electrode at a predetermined current density and for a predetermined duration. For example, a 4 mAh cm⁻² Li metal can be prelithiated in an anode at a current density of 1 mA cm⁻² for 4 hours, or at a current density of 2 mA cm⁻² for 2 hours. The current density for the prelithiation can be 0.1 mA cm⁻² or more (e.g., 0.5 mA cm⁻² or more, 1 mA cm⁻² or more, 2 mA cm⁻² or more, or 3 mA cm⁻² or more) and/or 4 mA cm⁻² or less (e.g., 3 mA cm⁻² or less, 2 mA cm⁻² or less, 1 mA cm⁻² or less, or 0.5 mA cm⁻² or less). The duration of prelithiation can be 1 hour or more (e.g., 2 hours or more, 5 hours or more, 10 hours or more, 20 hours or more, or 30 hours or more) and/or 40 hours or less (e.g., 30 hours or less, 20 hours or less, 10 hours or less, 5 hours or less, or 2 hours or less).

Thus, in some embodiments, the present disclosure features a method of prelithiating an anode, including providing an anode including an anode active material, where the anode active material is as described above; providing a lithium source; and prelithiating the anode active material using the lithium source to provide a prelithiated anode prior to an initial charge, wherein the anode active material hosts the lithium metal with an N/P ratio less than 1 as a function of a lithium intercalation cathode material.

The prelithiated anode can be incorporated into a cell including a cathode and a separator between the anode and the cathode.

In some embodiments, for preparation of the anode, an anode slurry can be made by mixing an anode active material with carbon black and a binder (e.g., polyvinylidene difluoride (PVDF) dissolved in n-methyl-2-pyrrolidone (NMP)), for example, in a ratio of 8:1:1, and then coating the slurry on an anode current collector. Examples of binders include for example, polyvinylidene difluoride, carboxymethylcellulose sodium, sodium alginate, and/or styrene-butadiene rubber: and are described, for example, in ACS Energy Letters 2021, 1550-1559, herein incorporated by reference in its entirety. Examples of additives in the anode include carbon black, acetylene black, KS-6 graphite, and/or super 65 carbon. In some embodiments, coating the anode active material onto a current collector can be by a doctor blade method, an atomic layer deposition, a chemical vapor deposition, a physical vapor deposition, and/or sputtering to provide the anode.

As an example, in some embodiments, the method of making a full cell includes (a) coating a thin-layer of an anode active material (e.g., a hard carbon) on a current collector (e.g., a Cu current collector); (b) controlling the amount of anode active material to less than 1 mg cm⁻² and controlling the thickness of electrode to less than 30 µm; (c) using electrochemical deposition to prelithiate the anode active material with lean lithium metal, where the electrochemical prelithiation capacity varies from 1 mAh cm⁻² to 4 mAh cm⁻²; and (d) assembling the full cell with a cathode having a cathode material (e.g., LiNiₓCo_{y}Mn_{1-x-y}O₂ (x≥0.6, NCM)) on a cathode current collector with an area capacity of > 4 mAh cm⁻², a separator, and under lean electrolyte conditions.

### Operation of the Full Cells

The prelithiated full cell of the present disclosure can have precisely controlled amounts of lithium metal. The anode active material (e.g., hard carbon) as a stable layer can protect deposited lithium metal by isolating the lithium metal from electrolytes. At lean lithium metal (N/P ratio ≤ 1) long cycle stability of full cells can be maintained.

For example, the cycle stability of a full cell that uses hard carbon coated on Cu current collector as an anode electrode can be superior to that of a comparative full cell that uses a pure Cu current collector, when coupled with a NCM cathode. The hard carbon can go through Li⁺ intercalation and the Li deposition during the initial charge process. The mass loading of hard carbon can be low in the present disclosure (< 1 mg cm⁻¹), which means that most of the cell capacity is believed to derive from the Li-deposition capacity.

As will be shown in the Example below, it was surprisingly found that the cycle stability (as measured by the capacity retention during battery cycle) can be improved if a prelithiated anode active material (e.g., a hard carbon) is used in an anode. In the present disclosure, the capacity retention ratio is used to evaluate the cycle stability, e.g., the initial discharge capacity is A and maintained at B after X cycles. and the capacity retention ratio is [B/A*100%], which is range is from 0 to 100%. A higher (B/A* 100%) means a higher cycle stability. A capacity retention ratio of at least 80% after 200 cycles is considered to be a high cycle stability.

In some embodiments, the full cell of the present disclosure can have a capacity retention of greater than 80% (e.g., greater than 85%, greater than 90%, greater than 95%, or greater than 97%) after 50 charge/discharge cycles. In some embodiments, the full cell of the present disclosure can have a capacity retention of greater than 80% (e.g., greater than 85%, greater than 90%, greater than 95%, or greater than 97%) after 200 charge/discharge cycles.

As an example, a half-cell can be assembled using hard carbon and lithium metal. The cell can be discharged to 0 V (Li/Li⁺) to complete an electrochemical prelithiation process. Exemplary cells can be disassembled (e.g., under inert atmosphere) and then the prelithiated electrode can be removed. Then, a new full cell can be assembled using the prelithiated anode and the cathode. The cycle stability of the cell can be significantly improved (e.g.. by greater than 10%, greater than 12%, or greater than 15% after 50 cycles) compared to an analogous cell formed of anode active material that has not been prelithiated. For example, the capacity retention of a cell having a prelithiated anode can be 80% or more (e.g., 85.3%) after 50 cycles, compared to an analogous non-prelithiated cell having a capacity retention is 70.1% after 50 cycles.

Furthermore, it was surprisingly found that cycle stability can be further improved if lean lithium metal was prelithiated into an anode active material (e.g., a hard carbon) and used as an anode electrode in full cells. As an example, a half-cell can be assembled using an anode active material (e.g., a hard carbon) and lithium metal. The half-cells can be discharged with a capacity of 1 mAh cm⁻² to complete the electrochemical prelithiation process. The cells can be disassembled (e.g., under inert atmosphere) and then the prelithiated anode can be removed. Then, a full cell can be assembled using the prelithiated anode and a cathode. As will be discussed in the Example below, the capacity retention can be greater than 80% (e.g., 97.1%) after 50 cycles.

It was surprisingly found that the cycle stability can increase if the amount of prelithiated lithium metal is increased in an anode, for example, from 2 mAh cm⁻² (at a capacity retention of about 97.3% after 50 cycles) to 4 mAh cm⁻² (at a capacity retention of about 97.4% after 50 cycles). In some embodiments, the optimum range for the amount of prelithiated lithium metal is 4 ± 0.5 mAh cm^{-2,}

In some embodiments, a hard carbon coated on a Cu current collector can prolong the cycle life of a lithium battery. The prelithiated hard carbon can further improve the lifespan (i.e., the capacity retention) of full cells. Furthermore, the lean lithium metal on the prelithiated hard carbon can maintain the full cell cyclic capacity and stability (e.g., a cell including a prelithiated hard carbon can have greater stability after 50 charge/discharge cycles compared to a non-prelithiated cell). In some embodiments, a full cell can exhibit a high energy density (i.e., an energy density of greater than 350 Wh kg⁻¹) and long cycle life (i.e., at least 80% capacity retention at 200 or more charge/discharge cycles) based on an anode including a prelithiated hard carbon, a NMC cathode, polyethylene separator, and lean electrolytes.

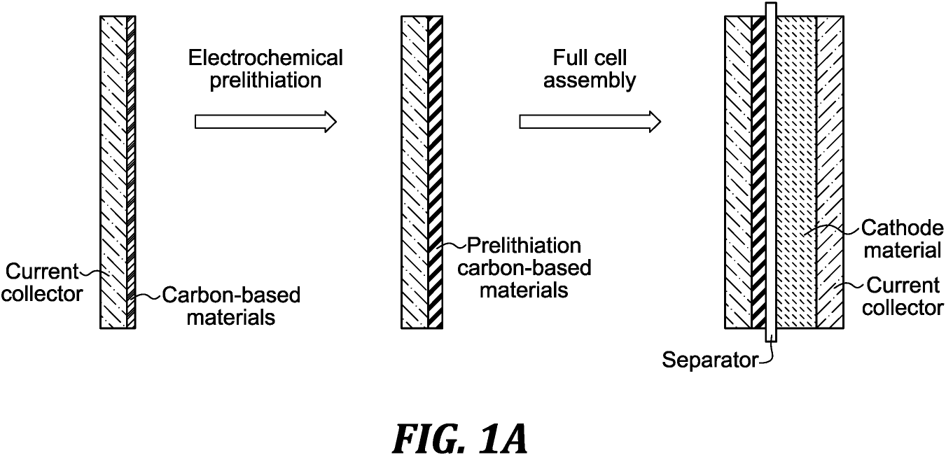

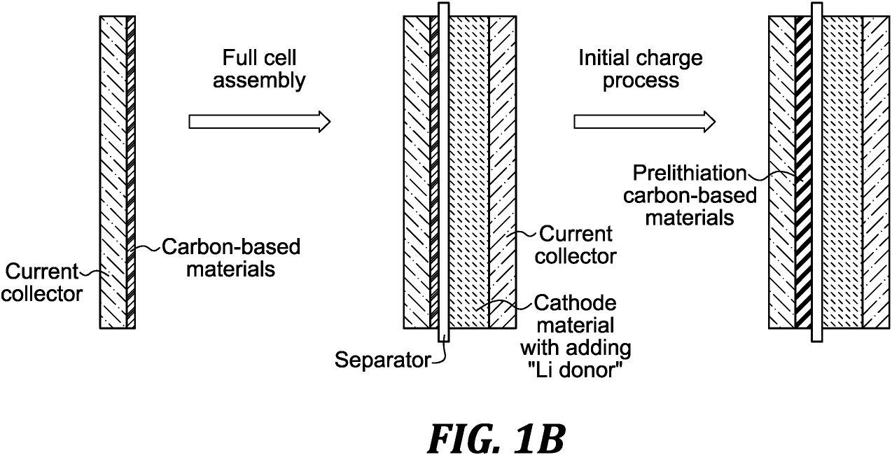

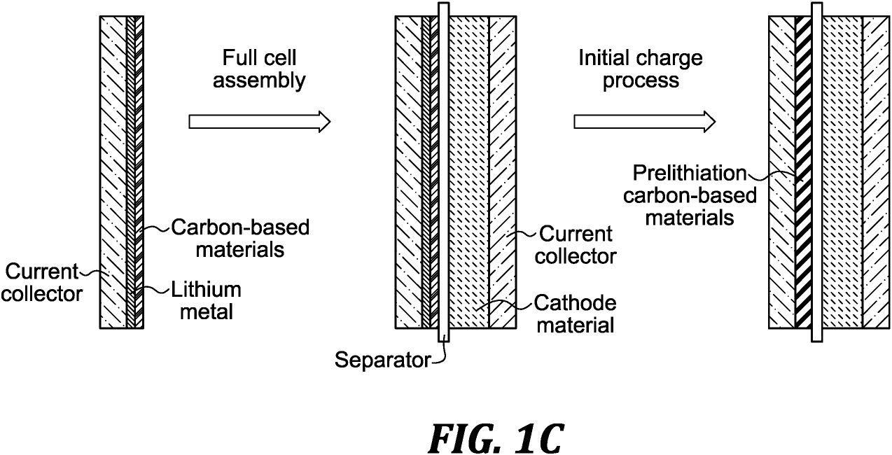

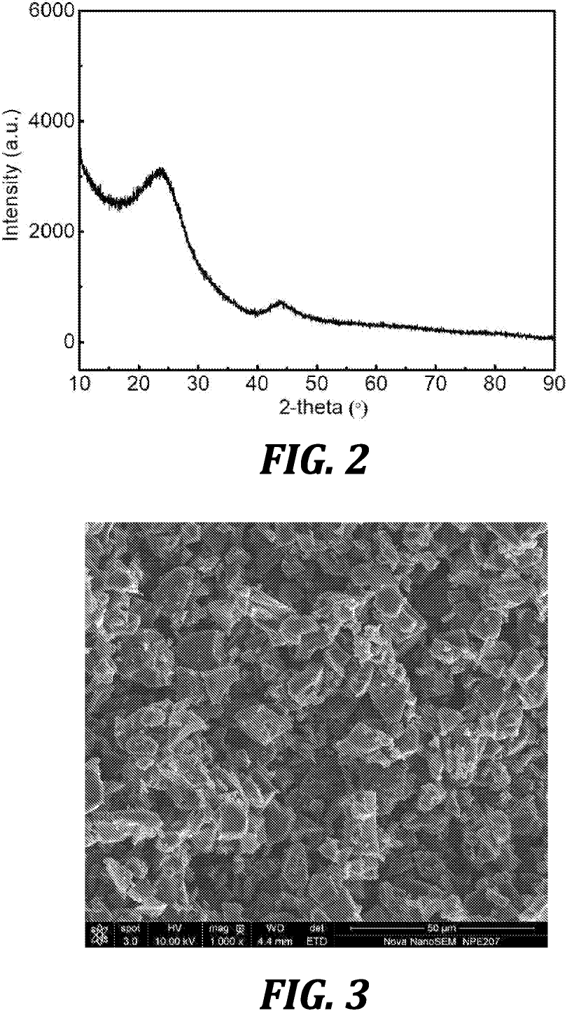

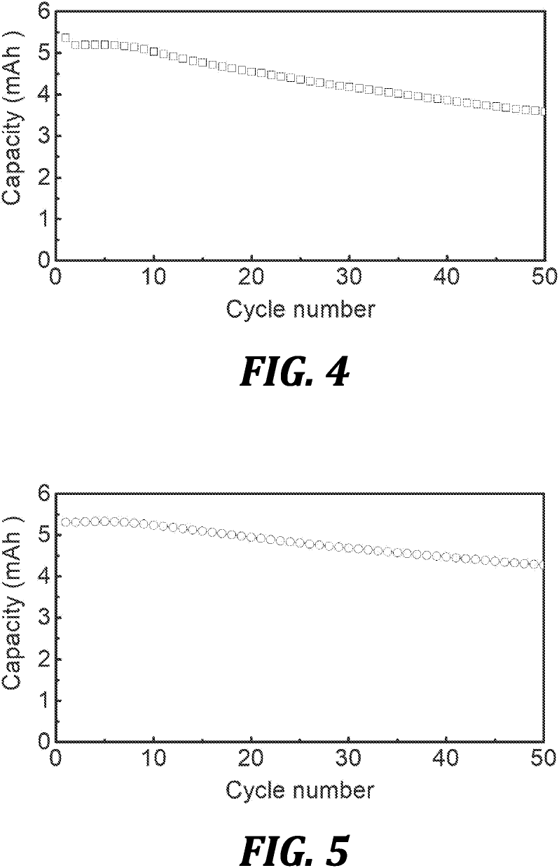

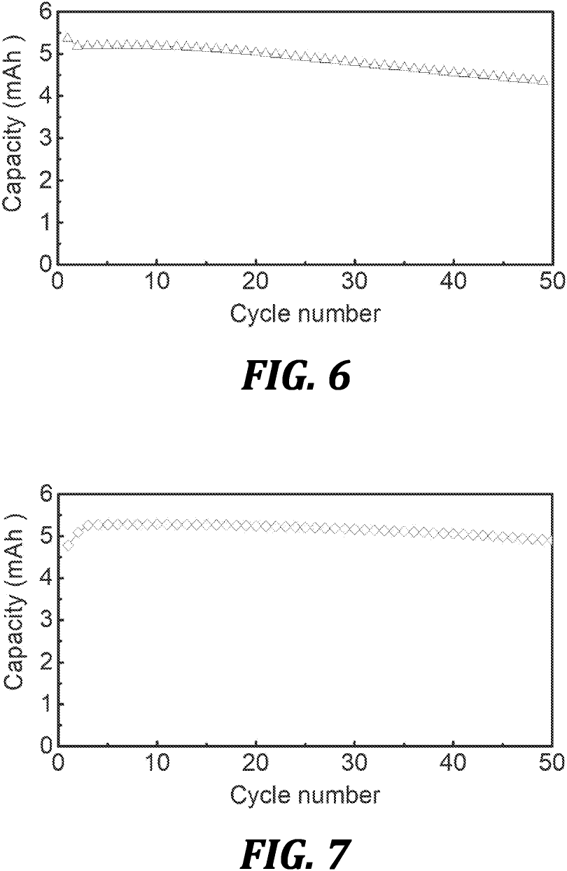

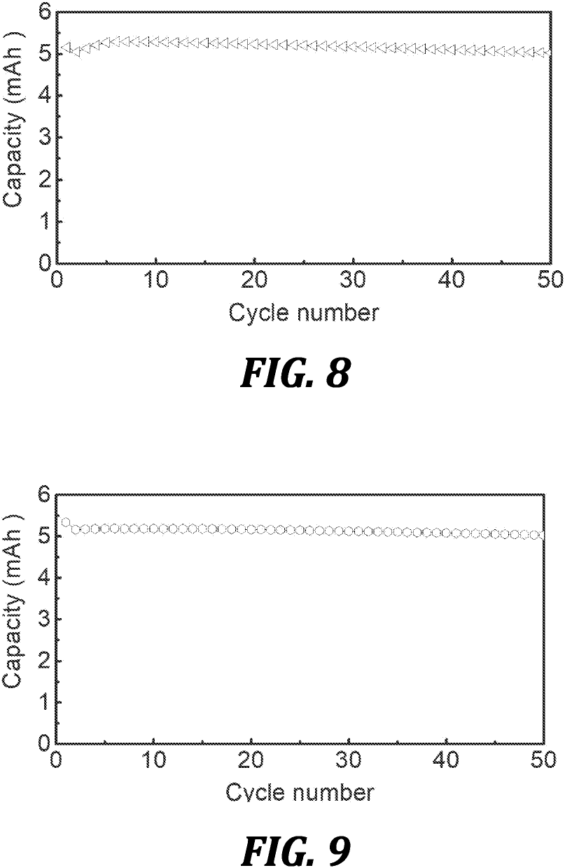

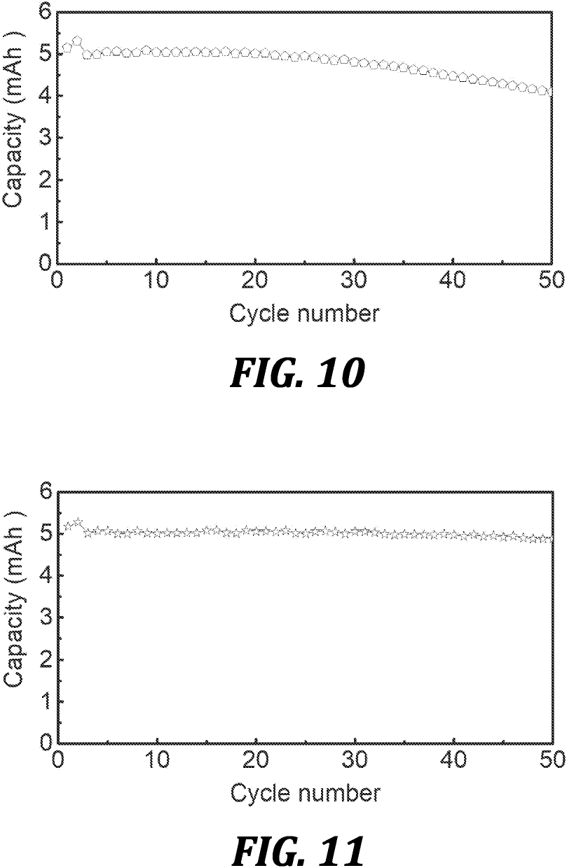

In some embodiments, the present disclosure provides a prelithiated hard carbon with lean lithium metal for lithium batteries. In one embodiment, as shown in FIGS. 1A, 1B, and 1C, a prelithiated hard carbon can include very thin layer of anode active material (e.g.. a hard carbon) coated on the current collector (e.g., a hard carbon mass loading can be below 1 mg cm⁻² and thickness can be below 30 µm, e.g., 6-12 µm thickness); and the anode active material can be prelithiated by electrochemical deposition, by coating a lithium metal on current collector, or by adding “Li donor” additives in cathode materials, where the amount of lithium metal is in the range from 1 to 4 mAh cm⁻². Without wishing to be bound by theory, it is believed that using current collectors or lean lithium as the anode material in lithium batteries provides very poor cycle performance (see, FIGS. 4 and 10) due to the continuous reaction of the deposited lithium metal with the electrolyte. However, a small amount of an anode active material, such as hard carbon, coated on the current collector can form a stable solid-state interface (SEI) to isolate the deposited lithium metal from the electrolyte, thereby improving the cycle life of full cell (see, FIG. 5). However, formation of the SEI and the irreversible capacity of the anode active material (e.g., hard carbon) can consume the limited lithium resource, restricting the lifespan of full cell. Electrochemical deposition, coating lithium metal on current collector with a hard carbon layer, or adding “Li donor” additives in cathode materials to prelithiate the hard carbon can solve these problems. The lean lithium metal in the anode can prolong the cycle life of full cell (see, FIGS. 6-9 and 11) and improve the energy density of lithium batteries.

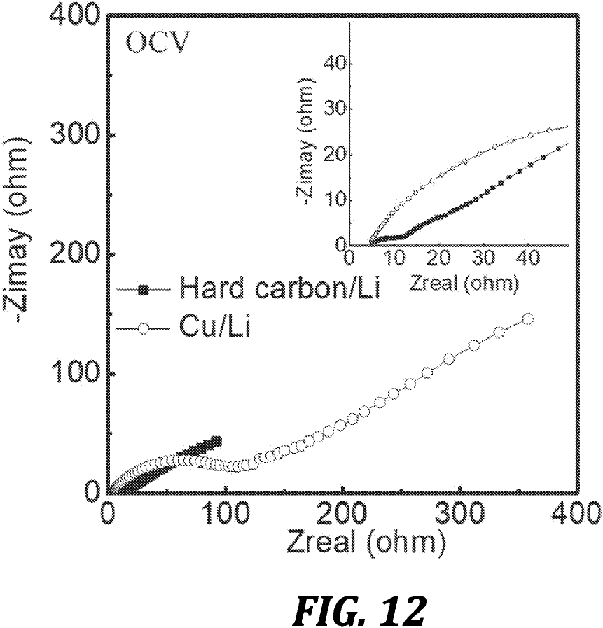

The EIS results of an example prelithiated hard carbon (4 mAh cm⁻²)//NCM622 (LiNi_{0.6}C_{O0.2}Mn_{0.2}O₂) full cell at OCV are shown in FIG. 12. For comparison, as shown in FIG. 12, the predeposited copper foil (4 mAh cm⁻²) anode/NCM622 cathode full cell can also be measured under the same conditions. At OCV state, the Nyquist plots of prelithiated hard carbon (4 mAh cm⁻²)//NCM622 shows two semicircles in the high frequency region, while the predeposited copper foil anode and NCM622 cathode full cell displays a semicircle in the similar frequency region. The impedance fitting results show that the total resistance of the prelithiated hard carbon//NCM622 cell is, for example, 40.9 Ω, which is much lower than that of the predeposited copper foil//NCM622 cell (e.g., 133.4 Ω). This indicates that the prelithiated hard carbon can greatly decrease the cell resistance. In addition, the prelithiated hard carbon anode has one more interface than the predeposited copper anode, which results from the presence of an additional protective layer. The stable electrode/electrolyte interface in the prelithiated hard carbon//NCM622 cell contributes to its better cycling performance.

The prelithiated hard carbon electrode with lean lithium metal of the present disclosure is not limited to use in in lithium metal batteries using intercalation-based cathodes, but can be applied to lithium-sulfur, lithium-air rechargeable batteries, electrochemical supercapacitors, and/or hybrid-supercapacitors. While hard carbon is described herein, the hard carbon can be replaced by a carbon material different from the hard carbon material (e.g.. a carbon fiber, a carbon nanotube, a graphene, a graphite, and/or a doped carbon material); an element including N, O, P, S, C1, Br, and/or I; an alloy including Ag, Au, Mg, Zn, Si, Ge, Sn, Pb, Sb, Bi, and/or Al; an oxide including TiO₂, SiOₓ, GeO₂, and/or SnO₂: a nitride such as Li₃N and/or Sn₃N₄; and/or a sulfide such as Li₂S. TiS₂.

### EXAMPLE

### Example 1. Prelithiated Hard Carbon With Lean Lithium Metal as Anode in Lithium Metal Full Cell

Commercial hard carbon material was used directly without further treatment. The negative electrode was prepared by mixing hard carbon, carbon black, and polyvinyl difluoride binder (PVDF, dispersed in 1-methy1-2-pyrrolidinone) in a weight ratio of 8:1:1. The slurry was coated on the Cu current collector by doctor blade method. The thickness was controlled as 30 µm. Commercial LiNi_{0.6}C_{O0.2}Mn_{0.2}O₂ or LiNi_{0.8}CO_{0.1}Mn_{0.1}O₂ material was used directly without further treatment. The positive electrode was prepared by mixing LiNi_{0.6}CO_{0.2}Mn_{0.2}O₂ or LiNi_{0.8}Co_{0.1}Mn0.1O₂, carbon black, and PVDF binder in a weight ratio of 0.96:0.02:0.02. The slurry was coated on the A1 current collector by doctor blade method. The thickness was controlled as 200 µm. The films were dried at 80° C. for 2 h to remove the solvent and then pressed. Then the films were further dried in a vacuum oven at 80° C. for 12 h. The dried electrode was pouched into discs with a diameter of 13 mm. The average mass loading for the negative and positive electrode is ~0.6 mg cm⁻² and ~25 mg cm-², respectively.

The LiFSI-1.2DME-3TTE (1: 1.2: 3 in molar ratio) ternary mixture was used as electrolyte. Polyethylene was employed as separator. The half-cell (2032-cype coin cell) composed of the hard carbon and lithium metal was assembled in glove box with the content of O₂ and H₂O < 0.1 ppm. The half cells were discharged to complete the prelithiation process. The amount of lithium metal in hard carbon was determined by the current density and galvanostatic discharge time. The amount of deposited lithium was set to 1-4 mAh cm⁻² in this experiment. Next, the coin cells were disassembled in glove box to take out the prelithiated hard carbon electrode and couple with positive electrode to fabricate the full cell. The full cells with LiNi_{0.6}Co_{0.2}Mn0.2O₂ cathode were charge/discharge at C/10 in the first cycle and then cycled at a C/10 charge and a C/3 discharge within the voltage window of 2.7-4.4 V. The full cells with LiNi_{0.8}CO_{0.1}Mn_{0.1}O₂ cathode were charge/discharge at C/10 in the first two cycles and then cycled at a C/3 charge and a C/3 discharge. The voltage window was 2.8-4.4 V. All electrochemical measurements were carried out at 25° C.

The Cu//LiNi_{0.6}Co_{0.2}Mn_{0.2}O₂ and hard carbon//LiNi_{0.6}CO_{0.2}Mn_{0.2}O₂ full cells were tested as control cells. The diagrams of discharge capacity vs. cycle number are shown in FIGS. 4 and 5. Clearly, both cells exhibited apparent capacity fading. The cycle performance of hard carbon//LiNi_{0.6}CO_{0.2}Mn_{0.2}O₂ full cell was better than that of Cu//LiNi_{0.6}Co_{0.2}Mn_{0.2}O₂ full cell, indicating the hard carbon played a positive role in the conservation of active lithium (Table 1). The cycle life of full cell has been correspondingly improved (FIG. 6) when a little amount of lithium was pre-deposited in hard carbon. The assembled full cells showed high cycle stability (FIG. 7-FIG. 9) when the amounts of pre-deposited lithium metals were set to 1, 2, 4 mAh cm⁻². Introducing a thin layer of hard carbon on Cu current collector can form a stable SEI film during the prelithiation process, which isolates the deposited lithium metal from electrolyte, improving the Coulombic efficiency and minimizing the side reaction. The prelithiation process provided lean lithium metal in negative electrode can greatly prolong the lifespan of full cells (Table 1).

TABLE 1

The cycling stability comparison of different full cells. The data are the retention rate after 50^{th} (calculated from 2^{nd} to 50^{th}). HC represents hard carbon, NCM622 represents LiNi_{0.6}CO_{0.2}Mn_{0.2}O₂. Prolithiation HC0 represents the hard carbon discharge to 0 V vs. Li/Li⁺ in half cell. Prelithiated HC1, HC2, HC4 represent the prelithiated capacity of 1, 2, 4 mAh cm⁻², respectively

| Full cell | Cu//NCM622 | HC/NCM622 | Prelithiated HC0//NCM622 | Prelithiated HC1//NCM622 | Prelithiated HC2//NCM622 | Prelithiated HC4//NCM622 |
|---|---|---|---|---|---|---|
| Retention rate after 50^{th} | 70.1% | 82.2% | 85.3% | 97.1% | 97.3% | 97.01% |

The cycle performance of Li//LiNi_{0.8}CO_{0.1}Mn_{0.1}O₂ and prelithiated hard carbon// LiNi_{0.8}C_{O0.1}Mn_{0.1}O₂ full cells are displayed in FIGS. 10 and 11, respectively. Both cells had a negative-to-positive capacity ratio of 0.4. The Li//LiNi_{0.8}CO_{0.1}Mn_{0.1}O₂exhibited obvious capacity deterioration after 30 cycles, indicating continuous Li loss during repeated Li plating/stripping. In comparison, the prelithiated hard carbon//LiNi_{0.8}Co_{0.1}Mn_{0.1}O₂ full cell showed a capacity retention of 97.4% after 50 cycles, indicating the high lithiation/delithiation reversibility of the prelithiated hard carbon (Table 2). In addition, this pre-stored Li in hard carbon could compensate for the Li consumption, and hence improve the cycle performance.

TABLE 2

Comparing the cycle stability of different full cells. The data are the retention rate after 50^{th}(calculated from 3^{rd} to 50^{th}). HC represents hard carbon, NCM811 represents LiNi_{0.8}CO_{0.1}Mn_{0.}₁O₂. Prelithiated HC1.6 represents the prelithiated capacity of 1.6 mAh cm⁻².

| Full cell | Li//NCM811 | Prelithiated HC1.6//NCM811 |
|---|---|---|
| Retention rate after 50^{th} | 82.2% | 97.4% |

The EIS results of an example prelithiated hard carbon (4 mAh cm⁻²)//NCM622 full cell at OCV are shown in FIG. 12. For comparison, as shown in FIG. 12, the predeposited copper foil (4 mAh cm⁻²) anode/NCM622 cathode full cell can also be measured under the same conditions. At OCV state, the Nyquist plots of prelithiated hard carbon (4 mAh cm⁻²)//NCM622 shows two semicircles in the high frequency region, while the predeposited copper foil anode and NCM622 cathode full cell displays a semicircle in the similar frequency region. The impedance fitting results show that the total resistance of the prelithiated hard carbon//NCM622 cell is, for example, 40.9 Ω, which is much lower than that of the predeposited copper foil//NCM622 cell (e.g.. 133.4 Ω). This indicates that the prelithiated hard carbon can greatly decrease the cell resistance. In addition, the prelithiated hard carbon anode has one more interface than the predeposited copper anode, which results from the presence of an additional protective layer. The stable electrode/electrolyte interface in the prelithiated hard carbon//NCM622 cell contributes to its better cycling performance.

The prelithiated hard carbon electrode with lean lithium metal of the present disclosure is not limited to use in in lithium metal batteries using intercalation-based cathodes, but can be applied to lithium-sulfur, lithium-air rechargeable batteries, electrochemical supercapacitors, and/or hybrid-supercapacitors.

By example and without limitation, embodiments are disclosed according to the following enumerated paragraphs:

A1. A lithium full cell, comprising:
an anode comprising an anode active material and an anode current collector, wherein the anode active material comprises a hard carbon material, a carbon fiber, a carbon nanotube, a graphene, a graphite, a doped carbon material, or any combination thereof:
a cathode comprising a cathode active material and a cathode current collector,
a separator between the anode and the cathode; and
an electrolyte wetting the anode, the cathode, and the separator,
wherein the anode active material is prelithiated with a lithium metal prior to an initial charge and
wherein the prelithiated anode active material hosts the lithium metal and comprises an N/P ratio of less than 1 as a function of the cathode active material.

A2. The lithium full cell of Paragraph A1, wherein the anode comprises an average active material mass loading of less than 1 mg cm⁻² for anode and the cathode comprises an average active material mass loading of up to 25 mg cm⁻², and wherein the full cell reaches a specific energy of at least 350 Wh kg⁻¹.

A3. The lithium full cell of Paragraph A1 or Paragraph A2, wherein the full cell comprises a lean lithium metal, lean electrolyte, and a high mass loading cathode.

A4. The lithium full cell of any one of Paragraphs A1 to A3, wherein the hard carbon material is substituted with:
a carbon material different from the hard carbon material,
an element comprising N, O, P, S, C1, Br, I, or any combination thereof,
an alloy comprising Ag. Au. Mg, Zn. Si, Ge, Sn, Pb, Sb, Bi, Al, or any combination thereof,
an oxide comprising TiO₂, SiOₓ, GeO₂, SnO₂. or any combination thereof,
a nitride comprising Li₃N, Sn₃N₄, or any combination thereof, and/or
a sulfide comprising Li₂S, TiS₂, or any combination thereof.

A5. The lithium full cell of any one of Paragraphs A1 to A4, wherein the anode active material comprises a thickness of from 1 µm to 30 µm.

A6. The lithium full cell of any one of Paragraphs A1 to A5, wherein the cathode active material comprises a capacity of greater than 200 mAh/g and an operation potential of greater than 4.0 V vs. Li/Li⁺.

A7. The lithium full cell of any one of Paragraphs A1 to A7, wherein the cathode active material comprises high-nickel-content lithium nickel manganese cobalt oxide (high-Ni NCM) (Ni ≥ 60%). Li-rich layered cathode materials, lithium cobalt oxide (LiCoO₂), or any combination thereof.

A8. The lithium full cell of any one of Paragraphs A1 to A7, wherein the separator comprises a polyethylene film, a polypropylene film, a poly (tetrafluoroethylene) film, a polyvinyl chloride film, nonwoven cotton fibers, nonwoven nylon fibers, nonwoven polyester fibers, ceramic, rubber, asbestos, wood, hybrids thereof, derivatives thereof, or any combination thereof.

A9. The lithium full cell of any one of Paragraphs A1 to A8, wherein the electrolyte comprises LiFSI-DME-TTE.

A10. The lithium full cell of any one of Paragraphs A1 to A9, wherein the electrolyte comprises LiFSI-DME-TTE in a molar ratio of 1:1.2:3.

A11. The lithium full cell of any one of Paragraphs A1 to A10, wherein the electrolyte comprises lithium salts in a solvent.

A12. The lithium full cell of Paragraph A11, wherein the solvent comprises carbonates, ethers, or any combination thereof.

A13. The lithium full cell of Paragraph A12, wherein the carbonate is selected from ethylene carbonate (EC), diethyl carbonate (DEC), ethyl methyl carbonate (EMC), dimethyl carbonate (DMC), and propylene carbonate (PC); and the ether is selected from 1.3-dioxolane (DOL). 1,2-dimethoxyethane (DME), triethyl phosphate (TEP), 1,1,2,2-tetrafluoroethyl-2,2,3,3-tetrafluoropropyl ether (TTE), bis(2,2,2-trifluoroethyl) ether (BTFE), fluorinated ether (TFEE), and/or tetraethylene glycol dimethyl ether (TGEDEM).

A14. The lithium full cell of Paragraph A12 or Paragraph A13, wherein the solvent comprises a binary or ternary combination of the carbonates, ethers, or any combinations thereof.

A15. The lithium full cell of any one of Paragraphs A11 to A14. wherein the lithium salts comprise LiPF₆, LiAsF₆, LiTFSI, LiFSI, LiClO₄, LiBF₄, or any combination thereof.

A16, The lithium full cell of any one of Paragraphs A11 to A15, wherein the concentration of the lithium salts is from 0.5 to 4 mol L⁻¹ relative to the electrolyte volume.

A17. The lithium full cell of any one of Paragraphs A1 to A16, wherein the anode current collector comprises a copper (Cu) foil, a nickel foil, a stainless steel foil, a decorated copper foil, a decorated nickel foil, or any combination thereof.

A18. The lithium full cell of any one of Paragraphs A1 to A17, wherein the cathode current collector comprises an aluminum (A1) foil current collector, a stainless steel foil, a carbon-coated aluminum foil, or any combination thereof.

A19. The lithium full cell of any one Paragraphs A1 to A18. comprising an N/P capacity ratio of 0.25 or more and 1 or less.

A20. The lithium full cell of any one of Paragraphs A1 to A19, wherein the anode comprises a lithium provided by Li from the anode or cathode.

A21. The lithium full cell of any one of Paragraphs A1 to A20, wherein the lithium in the anode is provided by Li from a Li foil or Li power on the anode.

A22. The lithium full cell of any one of Paragraphs A1 to A21, wherein prelithiating the anode comprises electrochemical deposition of a lithium metal.

A23. The lithium full cell of any one of Paragraphs A1 to A20, wherein the anode comprises a lithium metal provided by an amount of Li donor additives in the cathode or a coating of a lean lithium metal on a negative current collector.

A24. The lithium full cell of Paragraph A23, wherein the Li donor additives comprise Li₃N. Li₂S, Li₂O, Li₃P. or any combination thereof.

A25. The lithium full cell of any one of Paragraphs A1 to A24, wherein the cell is selected from a lithium-sulfur battery, a lithium-air rechargeable battery, an electrochemical supercapacitor, a hybrid-supercapacitor, or any combination thereof.

A26. A method of prelithiating an anode, comprising:
providing an anode comprising an anode active material, wherein the anode active material comprises a hard carbon material, a carbon fiber, a carbon nanotube, a graphene, a graphite, a doped carbon material, or any combination thereof;
providing a lithium source; and
prelithiating the anode active material using the lithium source to provide a prelithiated anode prior to an initial charge,
wherein the anode active material hosts the lithium metal with metal with N/P ratio less than 1 as a function of a lithium intercalation cathode material.

A27. The method of Paragraph A26, further comprising coating the anode active material onto a current collector by a doctor blade method, an atomic layer deposition, a chemical vapor deposition, a physical vapor deposition, sputtering, or any combination thereof to provide the anode.

A28. The method of Paragraph A26 or Paragraph A27, wherein the lithium source comprises the anode, a cathode, or a combination thereof.

A29. The method of any one of Paragraphs A26 to A28, wherein the lithium source comprises a thin Li foil, a Li powder on the anode, or any combination thereof.

A30. The method of any one of Paragraphs A26 to A28, wherein prelithiating the anode comprises adding an electrolyte to electrically connect the anode active material and the lithium.

A31. The method of any one of Paragraphs A26 to A28, wherein the lithium source comprises a Li donor additive comprising Li₃N, Li₂S, Li₂O, Li₃P, or any combination thereof.

A32. The method of Paragraph A31, wherein prelithiating the anode active material comprises electrochemical decomposition of the Li donor additive.

A33. A method of making a lithium full cell, comprising:

incorporating the prelithiated anode made using the method of Paragraph A26 or Paragraph A27, into a cell comprising a cathode and a separator between the anode and the cathode.

A34. The method of Paragraph A33, wherein the lithium full cell comprises an N/P capacity ratio of between 0.25 or more and 1 or less.

While illustrative embodiments have been illustrated and described, it will be appreciated that various changes can be made therein without departing from the spirit and scope of the invention.

1. A lithium full cell, comprising:
an anode comprising an anode active material and an anode current collector, wherein the anode active material comprises a hard carbon material, a carbon fiber, a carbon nanotube, a graphene, a graphite, a doped carbon material, or any combination thereof;
a cathode comprising a cathode active material and a cathode current collector;
a separator between the anode and the cathode; and
an electrolyte wetting the anode, the cathode, and the separator,
wherein the anode active material is prelithiated with a lithium metal prior to an initial charge, and
wherein the prelithiated anode active material hosts the lithium metal and comprises an N/P ratio of less than 1 as a function of the cathode active material.

2. The lithium full cell of claim 1, wherein the anode comprises an average active material mass loading of less than 1 mg cm⁻² for anode and the cathode comprises an average active material mass loading of up to 25 mg cm⁻², and
wherein the full cell reaches a specific energy of at least 350 Wh kg⁻¹.

3. The lithium full cell of claim 1, wherein the full cell comprises a lean lithium metal, lean electrolyte, and a high mass loading cathode.

4. The lithium full cell of claim 1, wherein the hard carbon material is substituted with:
a carbon material different from the hard carbon material,
an element comprising N, O, P, S, Cl, Br, I, or any combination thereof,
an alloy comprising Ag, Au, Mg, Zn, Si, Ge, Sn, Pb, Sb, Bi, Al, or any combination thereof,
an oxide comprising TiO2, SiOx, GeO2, SnO2, or any combination thereof,
a nitride comprising Li3N, Sn3N4, or any combination thereof, and/or
a sulfide comprising Li2S, TiS2, or any combination thereof.

5. The lithium full cell of claim 1, wherein the anode active material comprises a thickness of from 1 µm to 30 µm.

6. The lithium full cell of claim 1, wherein the cathode active material comprises a capacity of greater than 200 mAh/g and an operation potential of greater than 4.0 V vs. Li/Li+.

7. The lithium full cell of claim 1, wherein the cathode active material comprises high-nickel-content lithium nickel manganese cobalt oxide (high-Ni NCM) (Ni ≥ 60%), Li-rich layered cathode materials, lithium cobalt oxide (LiCoO²), or any combination thereof.

8. The lithium full cell of claim 1, wherein the separator comprises a polyethylene film, a polypropylene film, a poly (tetrafluoroethylene) film, a polyvinyl chloride film, nonwoven cotton fibers, nonwoven nylon fibers, nonwoven polyester fibers, ceramic, rubber, asbestos, wood, hybrids thereof, derivatives thereof, or any combination thereof.

9. The lithium full cell of claim 1, wherein the electrolyte comprises LiFSI-DME-TTE.

10. The lithium full cell of claim 1, wherein the electrolyte comprises LiFSI-DME-TTE in a molar ratio of 1:1.2:3.

11. The lithium full cell of claim 1, wherein the electrolyte comprises lithium salts in a solvent.

12-16. (canceled)

17. The lithium full cell of claim 1, wherein the anode current collector comprises a copper (Cu) foil, a nickel foil, a stainless steel foil, a decorated copper foil, a decorated nickel foil, or any combination thereof.

18. The lithium full cell of claim 1, wherein the cathode current collector comprises an aluminum (Al) foil current collector, a stainless steel foil, a carbon-coated aluminum foil, or any combination thereof.

19. The lithium full cell of claim 1, comprising an N/P capacity ratio of 0.25 or more and 1 or less.

20. The lithium full cell of claim 1, wherein the anode comprises a lithium provided by Li from the anode or cathode.

21. The lithium full cell of claim 1, wherein the lithium in the anode is provided by Li from a Li foil or Li power on the anode.

22. The lithium full cell of claim 1, wherein prelithiating the anode comprises electrochemical deposition of a lithium metal.

23. The lithium full cell of claim 1, wherein the anode comprises a lithium metal provided by an amount of Li donor additives in the cathode or a coating of a lean lithium metal on a negative current collector.

24. (canceled)

25. The lithium full cell of claim 1, wherein the cell is selected from a lithium-sulfur battery, a lithium-air rechargeable battery, an electrochemical supercapacitor, a hybrid-supercapacitor, or any combination thereof.

26. Amethod of prelithiating an anode, comprising:
providing an anode comprising an anode active material, wherein the anode active material comprises a hard carbon material, a carbon fiber, a carbon nanotube, a graphene, a graphite, a doped carbon material, or any combination thereof;
providing a lithium source; and
prelithiating the anode active material using the lithium source to provide a prelithiated anode prior to an initial charge,
wherein the anode active material hosts the lithium metal with metal with N/P ratio less than 1 as a function of a lithium intercalation cathode material.

27-34. (canceled)
